(19) United States
(12) Patent Application Publication
(10) Pub. No.: US 2008/0148408 A1
(43) Pub. Date: Jun. 19, 2008

(54) System and method of parsing web page vulnerability and recording medium thereof

(75) Inventors: Hsin-Chieh Kao, Pingtung City (TW); Chih-Hung Lin, Jhonghe City (TW)

Correspondence Address: RABIN & Berdo, PC, 1101 14TH STREET, NW, SUITE 500, WASHINGTON, DC, 20005, US

(73) Assignee: INSTITUTE FOR INFORMATION INDUSTRY, Taipei City (TW)

(21) Appl. No.: 11/652,128

(22) Filed: Jan. 11, 2007

(30) Foreign Application Priority Data
Dec. 13, 2006 (TW) 095146762

(51) Int. Cl. G06F 11/00

(52) U.S. Cl. 726/25

(57) ABSTRACT

A system and a method of parsing web page element to detect web page vulnerability and a recording medium thereof are provided. The method includes parsing elements in a target web page after requesting a web page server for the target web page, fetching attackable elements from the parsed elements and converting the attackable elements into attackable components, and then using all of the attackable components to perform a penetrable test on the web page server, so as to download more indirect web pages, thereby increasing the test coverage. Moreover, repetitive or test-free elements can be filtered by converting the attackable elements into the attackable components, so as to accelerate the detection.

### CROSS-REFERENCE TO RELATED APPLICATIONS

This non-provisional application claims priority under 35 U.S.C. §119(a) on Patent Application No(s). 095146762 filed in Taiwan, R.O.C. on Dec. 13, 2006, the entire contents of which are hereby incorporated by reference.

### BACKGROUND OF THE INVENTION

1. Field of Invention

The present invention relates to a system of detecting web page vulnerability and a method thereof, and more particularly to a system of parsing web page element to detect web page vulnerability and a method thereof.

2. Related Art

HyperText Markup Language (HTML) is a markup language composed of a number of elements. As shown in FIG. 1, an element 100a at least includes a tag 110 formed by a “<” and a “>”, and at least an element name 111 of the element 100a is recorded in the tag 110, wherein the element attribute is selectively recorded depending on the actual circumstance. For example, two element attributes 112 of “name=“”” and “value=“”” are recorded in the tag 110, and no element attribute is recorded in an element 100d. Another type of element is, for example, an element 100b, which is composed of a start tag 110a and an end tag 110b, wherein the data “test connection” contained between the start tag 110a and the end tag 110b is an element content 103 of the element 100b. Another type of element is, for example, an element 100c, which includes not only a start tag 110a and an end tag 110b, but also other elements. For example, the element 100c including the element 100a and the element 100b is named as a “composite element”, and the elements contained in the composite element are referred to as “sub-elements” of the composite element, i.e. the elements 100a and 100b are the sub-elements of the element 100c.

The web page browser presents the information recorded in the web page to a user by a presentation method corresponding to each element after reading the web page including various elements. The method of producing each element of the web page in the web page server is basically divided into two types. After reading out each element from a file corresponding to the requested target web page, the web page server immediately transfers the elements to the web page browser, and such a web page is usually named as a static web page. Relatively, a web page also includes program codes besides elements, wherein the web page server executes the program codes first, and then transfers each element produced based on the executed programs to the web page browser. Such a web page is usually presented in different presentation manners according to different request parameters accompanied by the request, thus being named as a dynamic web page.

Along with the emergence of Internet, more and more services are provided through HTML on the web page browser of the user. In order to meet various requirements of the service providers, dynamic web pages are widely used, and even most of the services using dynamic web pages are integrated with database, such that the user can receive more individualized services after providing his/her user data.

However, it is necessary for an individualized service to store part of the user data on the web page server, thus it is likely to attract those of evil intentions. In order to steal the user data stored on the web page server from the web page server, those of evil intentions attack the web page server to obtain the data stored on the web page server. The web page server is usually attacked through the security vulnerability of the programs executed on the web page server or the compile defect of the program codes contained in the dynamic web page, and the loss is generally considerable once the web page is attacked successfully.

In view of the above problems, the software or service for detecting web page vulnerability comes into being. However, the currently provided software or service is usually merely used to scan other links in the web page, and thus the same web page may be detected repeatedly, thereby alleviating the detection efficiency. Moreover, the currently provided software does not scan indirect web pages. As shown in FIG. 2, when the web page “index.php” on a web page server 200 is scanned, only the-links of “cart.php” and “login.php” are scanned from the source code of the web page before login, and the link of “member.php” emerged in the “index.php” after the login of the member cannot be scanned, thus resulting in an insufficient test coverage. In order to increase the test coverage, in U.S. Pat. No. 6,996,845, a web page is obtained after using account number and password to log in the website or a keyword is used to search for more web pages, and then the links in the newly obtained web pages are scanned. Although this method of detecting vulnerability can obtain more web pages, different web pages are produced according to different privileges after login, and thus it is difficult to obtain enough web pages to prevent various attacks at present. Therefore, how to detect indirect web pages in so far as possible to increase the test coverage as well as the detection speed has become a problem to be solved urgently by the software or service of detecting web page vulnerability.

### SUMMARY OF THE INVENTION

In view of the above problems, the present invention is directed to provide a system and a method of detecting web page vulnerability and a recording medium thereof. The method comprises: parsing elements in an target web page and converting attackable elements into attackable components, and then using all of the attackable components to perform a penetrable test to obtain more target web pages. Repetitive or test-free elements can be filtered by converting the attackable elements into the attackable components, so as to increase the test coverage and accelerate the detection, thereby solving the problems mentioned in the prior art.

In order to achieve the above objective, the system disclosed in the present invention comprises a data transmission module, a web page parsing module, a conversion module, and a test module.

The method disclosed in the present invention comprises: sending a request to a web page server to download a first target web page; parsing the first target web page to fetch at least one first attackable element in the first target web page; converting the first element into a first attackable component; using the first attackable component to send a request to the web page server for a penetrable test; downloading at least one second target web page when the penetrable test is successful, fetching at least one second attackable element from the second target web page, converting the second element into a second attackable component, and using the second attackable component to send a request for a penetrable test.

The method disclosed in the present invention can achieve the same objective by recording corresponding computer executable programs into a recording medium and then executing the programs in a computer.

The detailed features and practice will be illustrated in detail in the following embodiments, and the technology in the invention is apparent to people skilled in the art according to the content of the present invention, and those skilled in the art can implement it accordingly. Moreover, the relative objectives and advantages of the present invention are apparent to those skilled in the art according to the disclosure and drawings of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a conventional element constitution diagram.

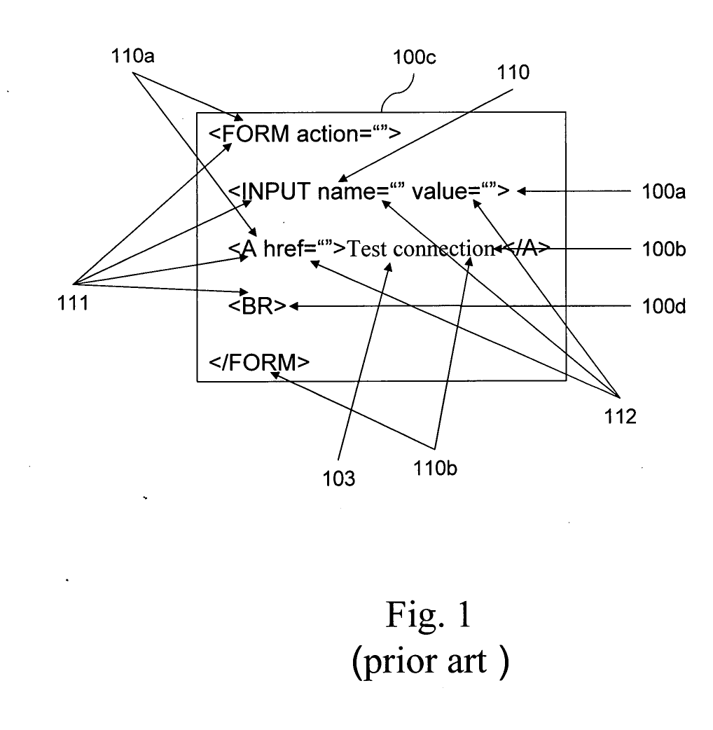

FIG. 2 is a schematic view of web pages in a web page server according to an embodiment of the present invention.

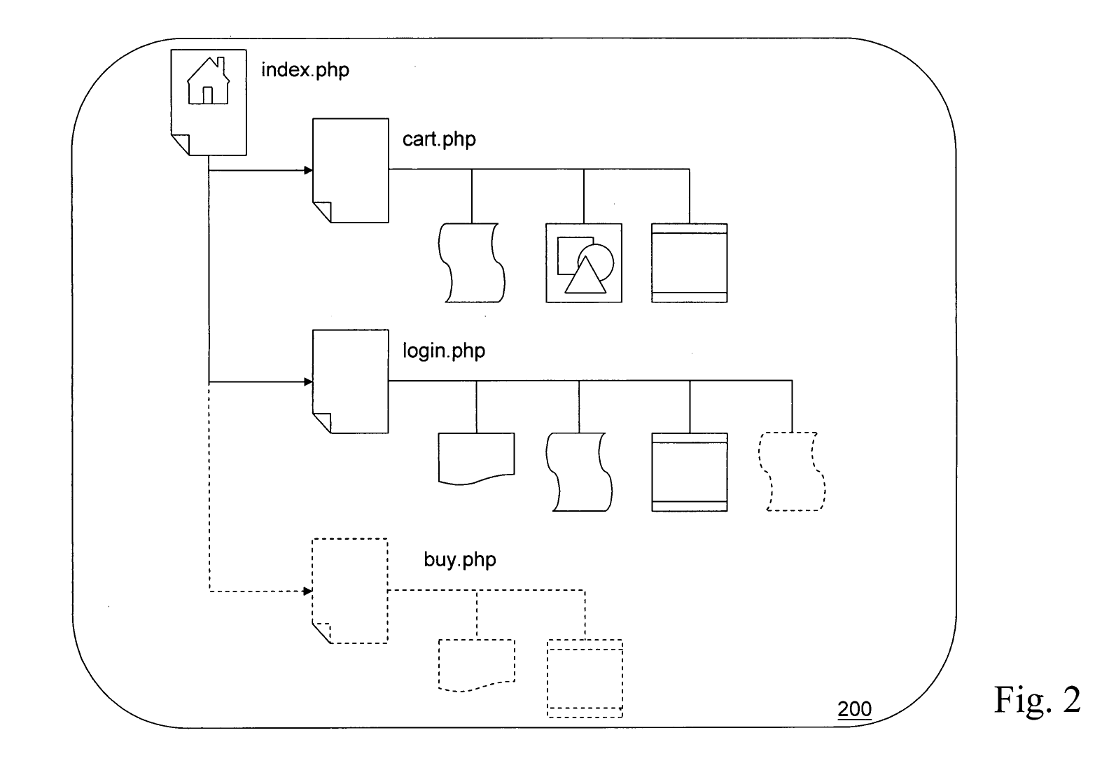

FIG. 3 is a system architectural view of parsing web page elements to detect web page vulnerability according to the present invention.

FIG. 4A is a method flow chart of parsing web page elements to detect web page vulnerability according to the present invention.

FIG. 4B is a method flow chart of the process of fetching and converting elements in parsing web page elements to detect web page vulnerability according to the present invention.

FIG. 5A shows a web page source code of “index.php” before login according to an embodiment of the present invention.

FIG. 5B shows a web page source code of “index.php” after login according to an embodiment of the present invention.

FIG. 6 is an attackable element table according to an embodiment of the present invention.

FIG. 7 is a schematic view of attackable elements according to an embodiment of the present invention.

### DETAILED DESCRIPTION OF THE INVENTION

The detection on web page vulnerability is divided into a penetrable test and an unpenetrable test, wherein the penetrable test refers to an attack for obtaining other privileges or hidden data, such as SQL injection, buffer overflow, privilege escalation, directory traversal; while the unpenetrable test refers to an attack that may cause a service paralysis or a loss of service demanders, such as denial of service (DoS), and cross site scripting (XSS).

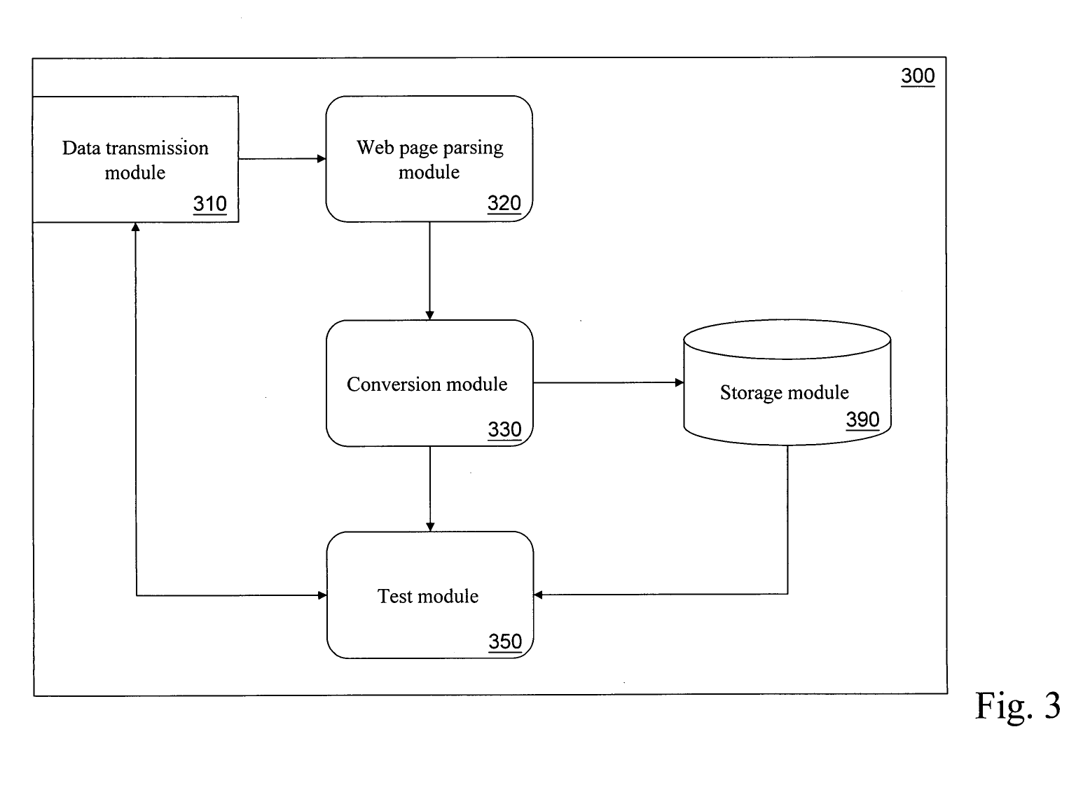

FIG. 3 is a system architectural view of parsing web page elements to detect web page vulnerability according to the present invention, which is taken below for illustrating the system operation of the present invention. As show in the figure, the system of the present invention includes a data transmission module 310, a web page parsing module 320, a conversion module 330, and a test module 350. The data transmission module 310 is responsible for sending a request to a web page server 200; and receiving a first target web page returned by the web page server 200 in response to the sent request. The web page parsing module 320 is responsible for parsing a first attackable element from the first target web page downloaded by the data transmission module 310. The conversion module 330 is responsible for converting the first element parsed by the web page parsing module 320 into a first attackable component. The test module 350 is responsible for using the first attackable component converted by the conversion module 330 to perform a penetrable test on the web page server 200.

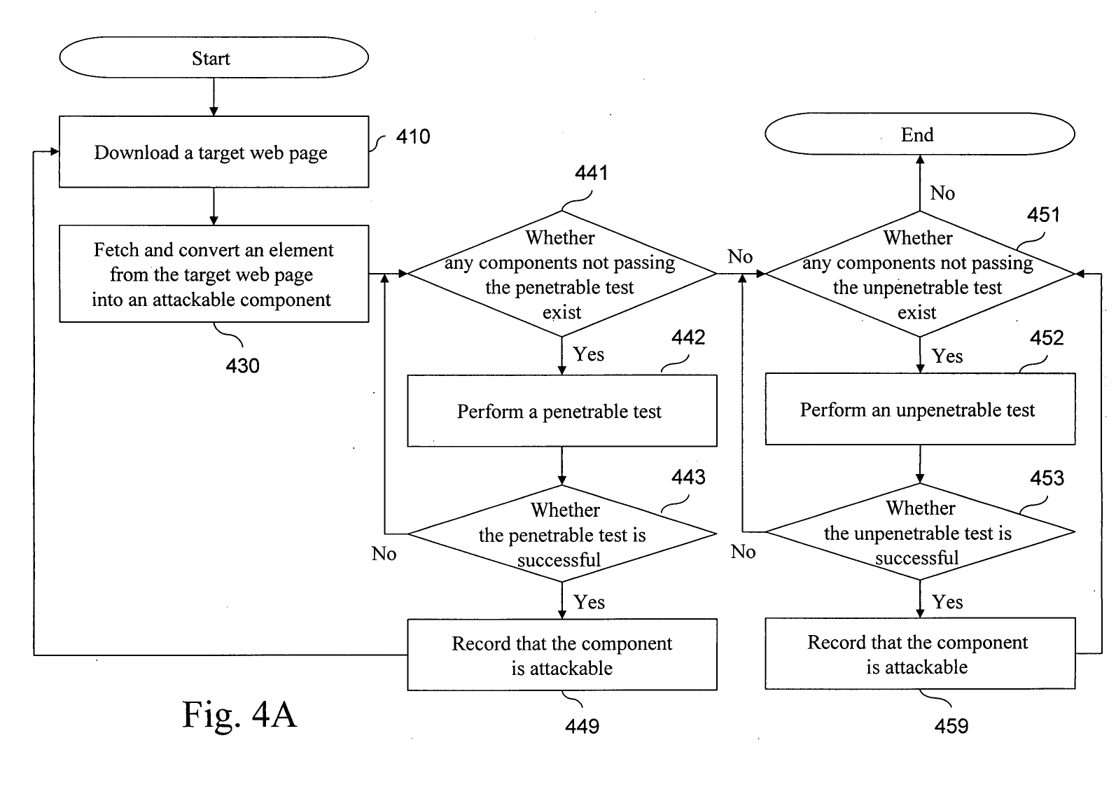

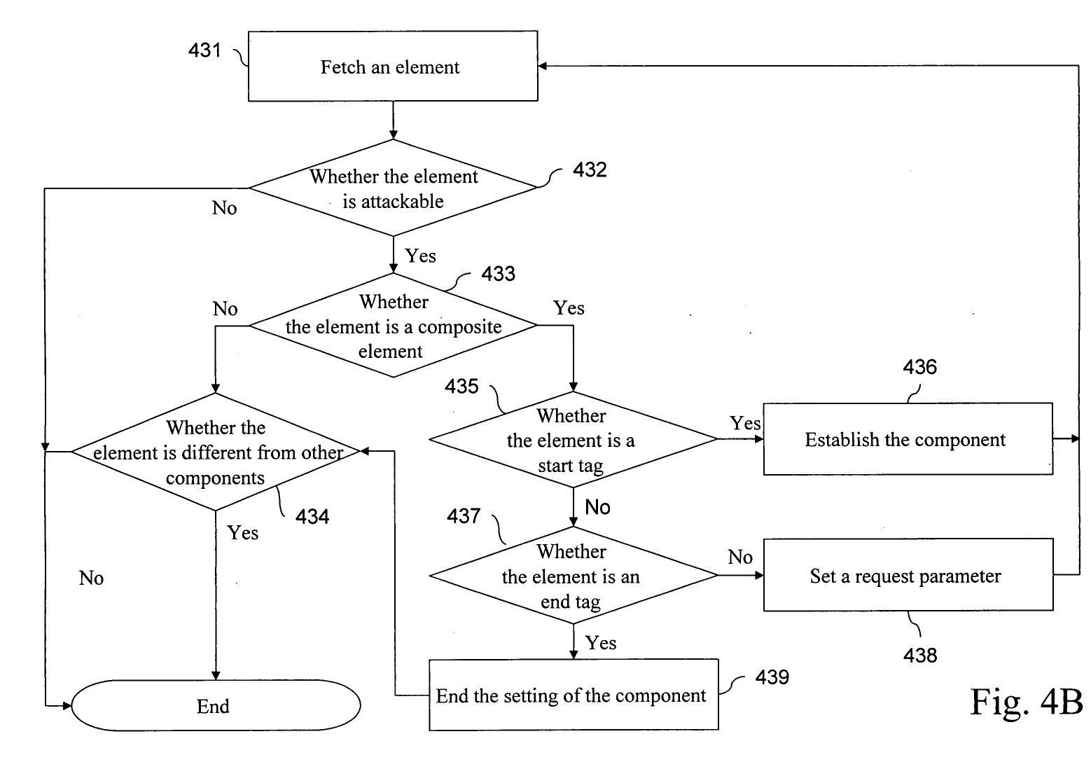

An embodiment is used below for illustrating the operating system and method of the present invention, and together referring to FIGS. 4A and 4B, they are flow charts of the method of parsing web page element to detect web page vulnerability according to the present invention.

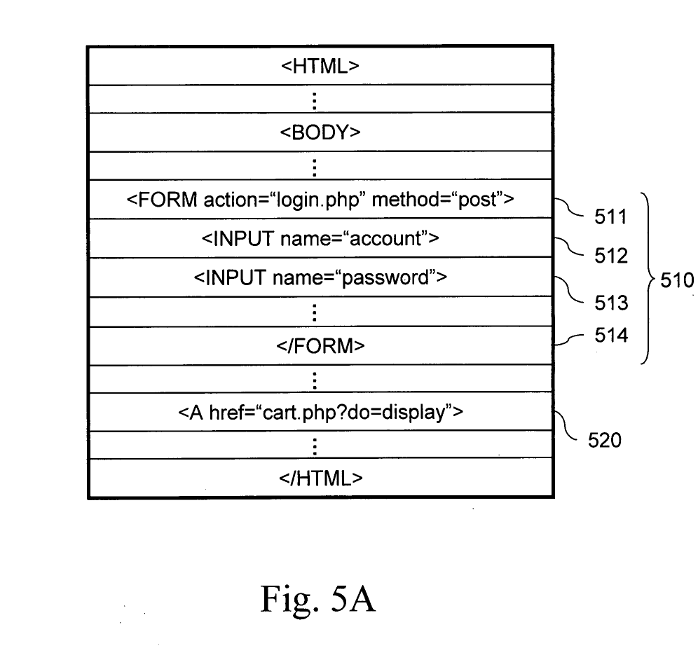

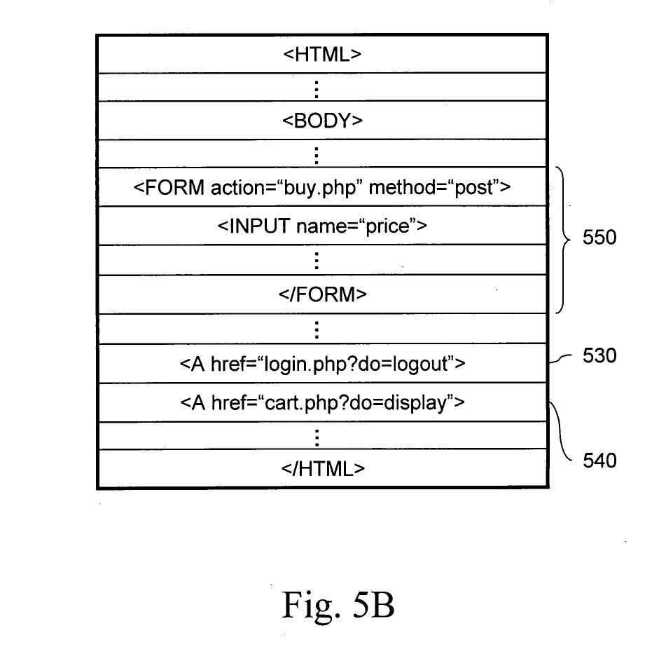

When the present invention performs the detection on web page vulnerability, the data transmission module 310 first sends a request for downloading a target web page to the web page server 200 with the web page vulnerability to be detected through a network. Generally, without designation, the target web page is usually the homepage of the web page server. In this embodiment, the homepage “index.php” is taken as an example as the target web page, wherein two links of “login.php” and “cart.php” are recorded in the web page source code of the “index.php”, as shown in FIG. 5A. After receiving the request of downloading the “index.php”, the web page server returns the “index.php” through the network to the data transmission module 310 of the present invention (Step 410). Then, the web page parsing module 320 of the present invention parses the web page source code of the “index.php”, and the conversion module 330 converts the attackable element parsed by the web page parsing module 320 into an attackable component provided for the test module 350 to perform a test (Step 430).

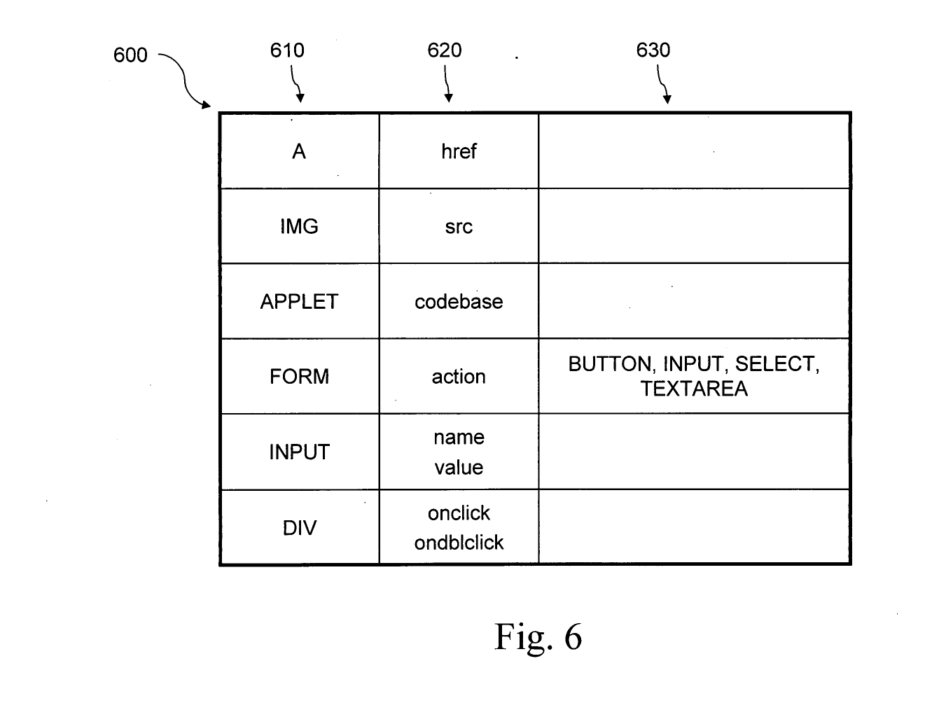

After the web page parsing module 320 parses the web page source code of the “index.php”, each element in the “index.php” can be fetched. As shown in FIG. 5A, the elements that can be fetched from the “index.php” are HTML, BODY, FORM, INPUT, A, and so on. Then, the web page parsing module 320 selects attackable elements from the fetched elements. In this embodiment, the web page parsing module 320 compares each element with an attackable element table 600 shown in FIG. 6, wherein when an element name and an element attribute are the same as the data recorded in an element name column 610 and an element attribute column 620 in the attackable element table 600, the element is an attackable element.

Generally, the elements recorded in the attackable element table 600 can be classified into three types: the first type is elements with element attribute related to link, for example, the element “A” with an element attribute of “href”, the element “IMG” with an element attribute of “src”; the second type is elements with element attribute related to variable, for example, the element “INPUT” with element attributes of “name” and “value”, and the composite element “FORM” taking a sub-element as the element attribute thereof; and the third type is elements with element attribute related to program code, for example, the element “DIV” with element attributes of “onclick”, “ondblclick”.

In the present invention, the method of selecting attackable elements is not limited to the above manner, and other methods of determining attackable elements can also be adopted.

After that, the conversion module 330 of the present invention converts the attackable elements into attackable components provided for the test module 350 to perform a test, so as to obtain a new target web page. For example, the conversion module 330 converts the element attribute “action=login.php” of a first element 510 with an element name of “FORM” into a new target web page “login.php”, and converts the element attribute “method” and the element attributes such as “name” and “value” of the sub-element “INPUT” of the first element 510 into a request parameter corresponding to the target web page “login.php”. Afterward, the conversion module 330 continues to fetch other attackable elements in the target web page “index.php”. For example, it can be known from the element attribute “href=cart.php?do=display” of a second element 520 that the new target web page is “cart.php?do=display”, and no additional parameters are provided.

The method of fetching and converting the elements into attackable components (Step 430) is further illustrated below. As shown in FIG. 4B, first, the first element 510 is fetched from the target web page “index.php” (Step 431), and then whether the fetched first element 510 is attackable or not is determined (Step 432). The determination method in this embodiment is comparing the first element 510 with the data in the attackable element table 600. It is found in FIG. 6 that the element name “FORM” of the first element 510 and the attribute name “action” thereof are present in the attackable element table 600, and thus the first element 510 is determined as an attackable element. If the fetched element is not an attackable element (not present in the attackable element table 600), the conversion is ended and the next element is fetched for conversion (Step 431).

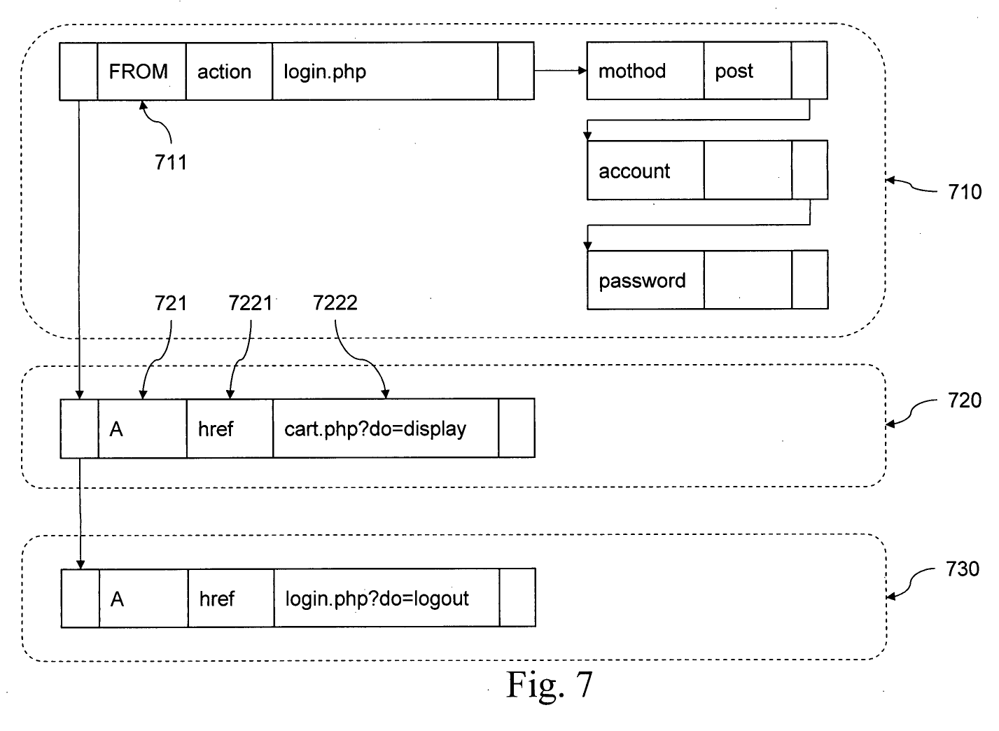

After the first element 510 is determined as an attackable element (Step 432), whether the first element 510 is a “composite element” is further determined (Step 433), wherein the element being not a “composite element” is a “single element”. A single element is an element having an attackable attribute, for example, the element “IMG” with an attackable attribute “src”. A composite element is composed of a major element and a set of sub-elements, which is not attackable when the elements thereof are separated from each other. For example, the element “FORM” is only attackable after being combined with the sub-elements such as “INPUT”, “SELECT”, and “TEXTAREA” by using the attributes of the sub-elements (e.g., element attributes such as “name= . . . ”). In this embodiment, the element with a sub-element recorded in the sub-element column 630 in the attackable element table 600 is a composite element. As the element name of the first element 510 is “FORM”, the sub-elements recorded in the sub-element column 630 include the elements such as BUTTON, INPUT, SELECT, and TEXTAREA, and thus the first element 510 is determined as a composite element (Step 433). When an element is a “composite element”, the subsequent elements are all sub-elements thereof till the fetched element is the end tag of the element. As shown in FIG. 5A, as the first tag (the first tag 511) contained in the first element 510 is a “start tag” (Step 435), a first attackable component is established (Step 436), the attack target is set as “login.php” according to the element attribute “action” recorded in the first tag 511, and the request parameter is set as “method=post” according to the element attribute “method”. After that, the fetched element is a first sub-element of the first element 510, and the first sub-element is composed of a second tag 512. As the element name of the first sub-element is recorded in the sub-element column 630 of the attackable element table 600, the first sub-element 512 is determined as neither the “start tag” nor the “end tag” (Step 437), such that the conversion module 330 sets the request parameter of the first attackable component as “account=” according to the element attribute of the first sub-element (Step 438). The second sub-element 513 is also composed of a third tag 513 which is neither the “start tag” nor the “end tag” (Step 437), and thus the conversion module 330 sets the request parameter as “password=” (Step 438). The last tag of the first element 510 is a fourth tag 514 which is the “end tag”, and thus the conversion module 330 ends the setting of the first attackable component (Step 439), such that the establishment of the first attackable component is accomplished. If a linked list is used in this embodiment as an attackable component, a first attackable component 710 is shown in FIG. 7.

Then, the next element in the target web page “index.php” is fetched, i.e., the second element 520 with an element name of “A” (Step 431). After being determined as an attackable element (Step 432), the second element 520 is further determined as a “single element” (Step 433), and thus the attack target “cart.php?do=display” is obtained from the attribute “href=cart.php?do=display” of the second element 520 by the conversion module 330 (Step 434).

After all the attackable elements in the target web page “index.php” is fetched and converted into the attackable components (Step 420), the test module 350 of the present invention starts to perform a penetrable test (Step 442). A method of performing the penetrable test by using SQL injection is adopted in this embodiment. First of all, the test module 350 reads out a first attackable component from a memory (e.g. the attack target is “login.php”, and the request parameters are “method=post”, “account=”, “password=”). Next, the value of “account” is set as an attack grammar for attacking the web page server, and the request parameters are transferred through the data transmission module 310 to the web page server in a POST way, so as to send a request to the web page server for downloading the target web page “login.php”. After receiving the request, the web page server first executes program codes in the “login.php” to produce the elements of the web page to be returned (also referred to as the source code). If the “login.php” has the vulnerability of SQL injection, the attack grammars set in the “account” are executed, such that the program codes in the “login.php” cannot be executed correctly. As a result, the web page server 200 considers that the present invention has successfully logged in by error, and the web page of successful login is thus returned. If the web page server 200 returns the “index.php” after the program codes in the “login.php” are executed in the web page server 200, the web page server 200 transfers the “index.php” after the successful login to the data transmission module 310 (Step 410).

Then, the web page parsing module 320 parses the newly received “index.php” in the same way as the original “index.php”, and the conversion module 330 performs the conversion to obtain an attackable component (Step 420). As shown in FIG. 5B, three attackable elements, respectively a third element 530, a fourth element 540, and a fifth element 550, are fetched from the new “index.php”. After the conversion module 330 converts the third element 530 and the fourth element 540 into attackable components, new target web pages “login.php?do=logout” and “cart.php?do=display” are obtained. A new target web page “buy.php” as an indirect web page is obtained after the conversion module 330 converts the fifth element 550, such that the present invention can effectively obtain an indirect web page, thereby increasing the test coverage of the present invention.

Moreover, when the web page parsing module 320 fetches a link from the element, the web page parsing module 320 further filters part of the strings in the link, such that the value of a variable in the link is wiped off. For example, after the elements in the new “index.php” are parsed and converted (Step 420), the test module 350 determines and reads out the attackable components that have not passed the penetrable test through SQL injection from the memory (Step 441). When the attack target of the read second attackable component is “cart.php?do=display”, if the value of the variable is wiped off from the link when the web page parsing module fetches the element, the attack target of the read second attackable component is changed into “cart.php?do=”. As such, the test module 350 can set the value of “do” as the grammar of attacking the web page server by means of SQL injection, so as to perform the penetrable test. If the penetrable test is successful (Step 443), the elements in the new web page transferred by the web page server are parsed and converted again; if not successful, whether other attackable components except the first or second attackable component exist to be read is determined again (Step 441), so as to carry on the penetrable test by means of SQL injection. The above process is repeated until all the attackable components pass the penetrable test by means of SQL injection. When all the attackable components pass the test by means of SQL injection, the test module uses other attack methods to perform a penetrable test on all the attackable components again. By repeating so, all the indirect web pages can be detected in so far as possible, thereby successfully solving the problem of a low test coverage mentioned in the prior art.

In the above test process, the web page parsing module 320 usually parses the same elements, and the conversion module 330 thus obtains the same attackable components through conversion, such that the test module 350 may use the same attackable components to perform the test repeatedly. In order to avoid repetitive tests, when converting the attackable elements into the attackable components (Step 430), the above conversion module 330 further determines whether the attackable components produced by the conversion are the same as the stored attackable components (Step 434), wherein the same components are not stored to prevent the test module 350 from using the same attackable components to perform the penetrable test. As shown in FIG. 7, the fourth element 540 is converted into a fourth attackable component and then compared with the first to third attackable components (710, 720, and 730). The component name is first compared, i.e. the name “A” of the fourth attackable component is compared with the first component name 711 of the first attackable component 710, wherein as the first component name 711 is FORM, the two are not the same. As a result, the second attackable component 720 is compared. As the second component name 721 of the second attackable component 720 is “A” which is identical to the component name of the fourth attackable component, the request parameters are further compared. Therefore, the parameter name “href” and parameter value “cart.php?do=display” of the first request parameter of the fourth attackable component are then compared with the first parameter name 7221 and the first parameter value 7222 of the first request parameter of the second attackable component, wherein as the first parameter name is also “href” and the first parameter value 7222 is also “cart.php?do=display”, the first request parameter of the second attackable component 720 is the same as the first request parameter of the fourth attackable component. As no other request parameters exist in the fourth and second attackable components, it is determined that the fourth attackable component is identical to the second attackable component, and thus the fourth attackable component is not added into the attackable component list.

If one of the above fourth and second attackable components includes other request parameters additionally, it is determined that the fourth attackable component is different from the second attackable component. Moreover, the arrangement sequence of the request parameters may not influence the result of requesting the target web page, and thus if the first parameter is different during the comparison, all other parameters are still needed to be compared.

When the web page parsing module 320 filters the value of the variable in a link, the present invention can avoid detecting the same attackable components repeatedly. For example, after the value of the variable in the link of the attack target of the above second attackable component is filtered, the attack target is changed into “cart.php?do=”. Therefore, if the element parsed by the web page parsing module 320 has the link of “cart.php?do=add”, after the value of the variable of the web page parsing module 320 is filtered, the target web page in the sixth attackable component converted by the conversion module 330 is “cart.php?do=”, which is the same as the attack target of the second attackable component, such that the sixth attackable component may not be added into the attackable list. Therefore, the present invention avoids continuously testing the same link added with Session Key or the value of a variable such as time, and thus the present invention is obviously superior to the conventional test manner.

After the test module 350 performs the penetrable test on the attackable component and determines that the penetrable test is successful, it is recorded that the attackable component is successful in the penetrable test for returning to the user for reference. For example, in the above embodiment, after using the first attackable component to perform the penetrable test (step 442), the test module 350 determines whether the login information is included in the received page “index.php”. For example, when searching for a word “logout”, if the login information is included in the received page, it is determined that the penetrable test is successful (Step 443), and thus it is recorded that the attackable component is successful in the penetrable test (Step 449).

Moreover, as the attack method includes not only the penetrable test, but also the unpenetrable test, after the test module 350 accomplishes the penetrable test, an unpenetrable test is further performed on the web page server 200. A manner of cross site scripting is taken as an example in this embodiment, wherein the test module 350 first reads out an attackable component, e.g., the third attackable component “buy.php?mag=” (Step 451), and thus the present invention sets the value of “msg” as a specific program code, and then sends a request to the web page server through “buy.php?msg=specific program code” (Step 452). If the web page “buy.php” has a vulnerability of cross site scripting, the web page server 200 stores the specific program code input by the test module 350 into the database when executing the program code in the “buy.php”, such that when the “buy.php” is downloaded later, the previously input specific program code is included therein. Thereby, when the web page browser presents each element in the “buy.php”, the previously input specific program code is executed. So, it is determined that the unpenetrable test is successful (Step 453), and thus it is recorded that the attackable component is successful in the unpenetrable test (Step 459). Afterward, the present invention determines whether other attackable components not passing the unpenetrable test exist or not, and if so, an unpenetrable test is performed continuously till all the tests are accomplished.

Moreover, the recording medium for parsing web page element to detect web page vulnerability provided by the present invention performs the steps described in the above embodiment after the computer executes the programs stored in the recording medium.

Further, the method of parsing web page element to detect web page vulnerability provided by the present invention can be realized in hardware, software, or a combination of hardware and software, or realized by a computer system in a centralized way, or a distributed way of distributing different components in several interconnected computer systems.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of parsing web page element to detect web page vulnerability, applicable to an electronic device, comprising:
sending a request to a web page server to download a first target web page;
parsing the first target web page to fetch at least one first attackable element from the first target web page;
converting the first element into a first attackable component;
using the first attackable component to send a request to the web page server for a penetrable test; and
when the penetrable test is successful, downloading at least one second target web page, fetching at least one second attackable element from the second target web page, converting the second element into a second attackable component, and using the second attackable component to send a request for the penetrable test again.

2. The method of parsing web page element to detect web page vulnerability as claimed in claim 1, wherein the step of parsing the first target web page to fetch at least one first attackable element in the first target web page further comprises a step of filtering the value of a variable of a link in the first element, so as to convert the links having the same variable name into the same first attackable component.

3. The method of parsing web page element to detect web page vulnerability as claimed in claim 1, further comprising a step of using the first attackable component to send a request to the web page server for an unpenetrable test.

4. The method of parsing web page element to detect web page vulnerability as claimed in claim 1, wherein the step of converting the first element into the first attackable component further comprises:
determining the first element as a single element or a composite element;
when the first element is a single element, setting the first attackable component corresponding to the first element as an element attribute value of the first element;
when the first element is a composite element, determining the type of each tag in the first element;
when the tag is a start tag, setting a target web page in the first attackable component corresponding to the first element as an element attribute value of the first element;
when the tag is not a start tag nor an end tag, setting each download parameter in the first attackable component corresponding to the first element as each attribute of each sub-element corresponding to the tag; and
when the tag is an end tag, ending the setting of the first attackable component.

5. The method of parsing web page element to detect web page vulnerability as claimed in claim 1, wherein the method further comprises a step of storing the first attackable component into an attackable component list when determining that the first attackable component is different from all the attackable components in the attackable component list.

6. The method of parsing web page element to detect web page vulnerability as claimed in claim 1, wherein the step of performing the penetrable test further comprises a step of recording that the first attackable component has successfully performed the penetrable test when the penetrable test is successful.

7. The method of parsing web page element to detect web page vulnerability as claimed in claim 1, wherein the step of performing the unpenetrable test further comprises a step of recording that the first attackable component has successfully performed the unpenetrable test when the unpenetrable test is successful.

8. A system of parsing web page element to detect web page vulnerability, applicable to an electronic device, comprising:
a data transmission module, for sending a request to a web page server to download a first target web page;
a web page parsing module, for parsing the first target web page to fetch at least one first attackable element from the first target web page;
a conversion module, for converting at least one first element into at least one corresponding first attackable component; and
a test module, for sending a request corresponding to the first attackable component through the data transmission module to the web page server for a penetrable test, and when the penetrable test is successful, receiving at least one second target web page through the data transmission module;
wherein, after the test module receives the second target web page, the web page parsing module parses the second target web page to fetch at least one second element and after the conversion module converts the second element into a second attackable component, the second attackable component is used for the penetrable test.

9. The system of parsing web page element to detect web page vulnerability as claimed in claim 8, wherein the web page parsing module is further used for filtering the value of a variable of a link in the first element.

10. The system of parsing web page element to detect web page vulnerability as claimed in claim 8, wherein the test module is further used for sending a request corresponding to the first attackable component through the data transmission module to the web page server for an unpenetrable test.

11. The system of parsing web page element to detect web page vulnerability as claimed in claim 8, wherein the test module is further used for recording that the first attackable component performs the penetrable test on the web page server.

12. The system of parsing web page element to detect web page vulnerability as claimed in claim 8, further comprising a storage module for storing the first attackable component when the web page parsing module determines that the first attackable component is different from all the attackable components stored in the storage module.

13. A recording medium of parsing web page element to detect web page vulnerability, for recording computer executable computer program codes, so as to execute the following steps in a computer:
sending a request to a web page server to download a first target web page;
parsing the first target web page to fetch at least one first attackable element from the first target web page;
converting the first element into a first attackable component;
using the first attackable component to send a request to the web page server for a penetrable test; and
when the penetrable test is successful, downloading at least one second target web page, fetching at least one second attackable element from the second target web page, converting the second element into a second attackable component, and using the second attackable component to send a request for the penetrable test again.

14. The recording medium of parsing web page element to detect web page vulnerability as claimed in claim 13, wherein the step of the recording medium adopting a computer to parse the first target web page to fetch at least one first attackable element from the first target web page while converting the first element into the first attackable element further comprises a step of filtering the value of a variable of a link in the first element, so as to convert the links having the same variable name into the same first attackable component.

15. The recording medium of parsing web page element to detect web page vulnerability as claimed in claim 13, further comprising a step of using the first attackable component to send a request to the web page server for an unpenetrable test.

16. The recording medium of parsing web page element to detect web page vulnerability as claimed in claim 13, wherein when the computer executes the step of converting the first element into the first attackable component, the recording medium further executes the following steps:
determining the first element as a single element or a composite element;
when the first element is a single element, setting the first attackable component corresponding to the first element as an element attribute value of the first element;
when the first element is a composite element, determining the type of each tag in the first element;
when the tag is a start tag, setting a target web page in the first attackable component corresponding to the first element as an element attribute value of the first element;
when the tag is not a start tag nor an end tag, setting each download parameter in the first attackable component corresponding to the first element as each attribute of each sub-element corresponding to the tag; and
when the tag is an end tag, ending the setting of the first attackable component.

17. The recording medium of parsing web page element to detect web page vulnerability as claimed in claim 13, wherein the recording medium further comprises a step of storing the first attackable component into an attackable component list when the computer determines that the first attackable component is different from all the attackable components in the attackable component list.

18. The recording medium of parsing web page element to detect web page vulnerability as claimed in claim 13, further comprising a step of recording that the first attackable component has successfully performed the penetrable test when the penetrable test is successful.

19. The recording medium of parsing web page element to detect web page vulnerability as claimed in claim 13, further comprising a step of recording that the first attackable component has successfully performed the unpenetrable test when the unpenetrable test is successful.
